(19) United States
(12) Patent Application Publication
(10) Pub. No.: US 2020/0240534 A1
(43) Pub. Date: Jul. 30, 2020

(54) SPOOL VALVE

(71) Applicant: DENSO CORPORATION, Kariya-city (JP)

(72) Inventors: Atsushi MOTOKI, Kariya-city (JP); Tsunehito WATANABE, Kariya-city (JP)

(21) Appl. No.: 16/773,215

(22) Filed: Jan. 27, 2020

(30) Foreign Application Priority Data
Jan. 29, 2019 (JP) 2019-012843

(51) Int. Cl. F16K 11/076

(52) U.S. Cl. CPC F16K 11/076

(57) ABSTRACT

A spool valve includes a sleeve and a spool. The sleeve has an inflow opening through which fluid flows in and an outflow opening through which the fluid flows out. The inflow opening opens in a radial direction of the sleeve and the outflow opening opens a same side with the inflow opening. The spool has a recess recessed from an outer peripheral part of the spool to a center axis of the spool. The spool is configured movable in the sleeve in an axial direction of the sleeve. The spool controls a communication state between the inflow opening and the outflow opening through the recess by regulating a position of the recess in the axial direction. A closed space is formed at a portion of the sleeve opposite to where the outflow opening is located.

### CROSS REFERENCE TO RELATED APPLICATION

This application is based on Japanese Patent Application No. 2019-12843 filed on Jan. 29, 2019, the disclosure of which is incorporated herein by reference in its entirety.

### TECHNICAL FIELD

The present disclosure relates to a spool valve.

### BACKGROUND

A spool valve is used to regulate a hydraulic pressure supplied to a friction element in an automatic transmission for a vehicle. The spool valve controls a communication state between an inflow opening and an outflow opening by moving a spool disposed inside a sleeve and regulating a position of a recess formed at the spool. Fluid flows in through the inflow opening and flows out through the outflow opening.

### SUMMARY

A spool valve has a sleeve having a substantially tubular shape and a spool disposed in the sleeve. The sleeve has an inflow opening through which fluid flows in and an outflow opening through which the fluid flows out. The inflow opening opens in a radial direction and the outflow opening opens at the same side with the inflow opening in the radial direction. The spool has a recess recessed from an outer peripheral part of the spool toward a center axis of the spool in the radial direction. The spool is configured movable in the sleeve in an axial direction of the sleeve. The spool controls a communication state between the inflow opening and the outflow opening through the recess by positioning the recess in the axial direction. A closed space is formed at a portion of the sleeve opposite to where the outflow opening is formed.

### BRIEF DESCRIPTION OF THE DRAWINGS

FIG. 1 is a schematic view of a hydraulic control device.

FIG. 2 is a schematic view of a spool valve according to a first embodiment.

FIG. 3 is a top view of a spool of the spool valve.

FIG. 4 is a schematic view of the spool valve in the first embodiment.

FIG. 5 is a cross section view of the spool valve viewed in an axial direction of the spool.

FIG. 6 is an enlarged view of a vicinity of an inflow opening and an outflow opening of a sleeve of the spool valve.

FIG. 7 is a cross section view of the spool valve viewed in the axial direction of the spool.

FIG. 8 is an enlarged view of the vicinity of the inflow opening and the outflow opening.

FIG. 9 is a schematic view of a spool valve in a comparison example.

FIG. 10 is a cross section view of the spool valve in the comparison example viewed in the axial direction of the spool.

FIG. 11 is an enlarged view of a vicinity of an inflow opening and an outflow opening of the comparison example.

FIG. 12 is a cross section view of a spool valve in a second embodiment viewed in the axial direction of the spool.

FIG. 13 is a cross section view of a spool valve in a third embodiment viewed in the axial direction of the spool.

FIG. 14 is a cross section view of a spool valve in a fourth embodiment viewed in the axial direction of the spool.

FIG. 15 is a cross section view of a spool valve in a fifth embodiment viewed in the axial direction of the spool.

### DETAILED DESCRIPTION

To begin with, examples of relevant techniques will be described.

A spool valve is used to regulate a hydraulic pressure supplied to a friction element in an automatic transmission for a vehicle. The spool valve controls a communication state between an inflow opening and an outflow opening by moving a spool disposed inside a sleeve and regulating a position of a recess formed at the spool. Fluid flows in through the inflow opening and flows out through the outflow opening.

In such the spool valve, the spool is rotated relative to a canter axis of the spool, so that the recess may be displaced from a desired position corresponding to the inflow opening and the outflow opening. In this case, a disturbance of oil flow in the sleeve is increased compared to a case where the recess is positioned at the desired position. The disturbance of the oil flow may disturb a movement of the spool. It is preferred that the disturbance of oil flow can be suppressed when the spool of the spool valve is rotated and the recess is displaced from the desired position.

According to an aspect of the present disclosure, a spool valve has a sleeve having a substantially tubular shape and a spool disposed in the sleeve. The sleeve has an inflow opening through which fluid flows in and an outflow opening through which the fluid flows out. The inflow opening opens in a radial direction and the outflow opening opens at the same side with the inflow opening in the radial direction. The spool has a recess recessed from an outer peripheral part of the spool toward a center axis of the spool in the radial direction. The spool is configured movable in the sleeve in an axial direction of the sleeve. The spool controls a communication state between the inflow opening and the outflow opening through the recess by positioning the recess in the axial direction. A closed space is formed at a portion of the sleeve opposite to where the outflow opening is formed. When the spool is rotated and the recess is displaced from a desired position corresponding to the inflow opening and the outflow opening, the oil may flow to a part of the sleeve opposite to where the outflow opening is located. According to the spool valve in this disclosure, the closed space formed on the part of the sleeve opposite to where the outflow opening is located returns the oil flow to the outflow opening. Thus, when the spool of the spool valve is rotated and displaced from the desired position, the disturbance of the oil flow is suppressed. This further suppresses the disturbance of the spool movement caused by the disturbance of the oil flow.

The present disclosure is realized for a spool valve and is also achieved in various embodiments other than the spool valve. This disclosure may be achieved in a hydraulic control device including the spool valve, and may be achieved in a vehicle having the hydraulic control device.

### FIRST EMBODIMENT

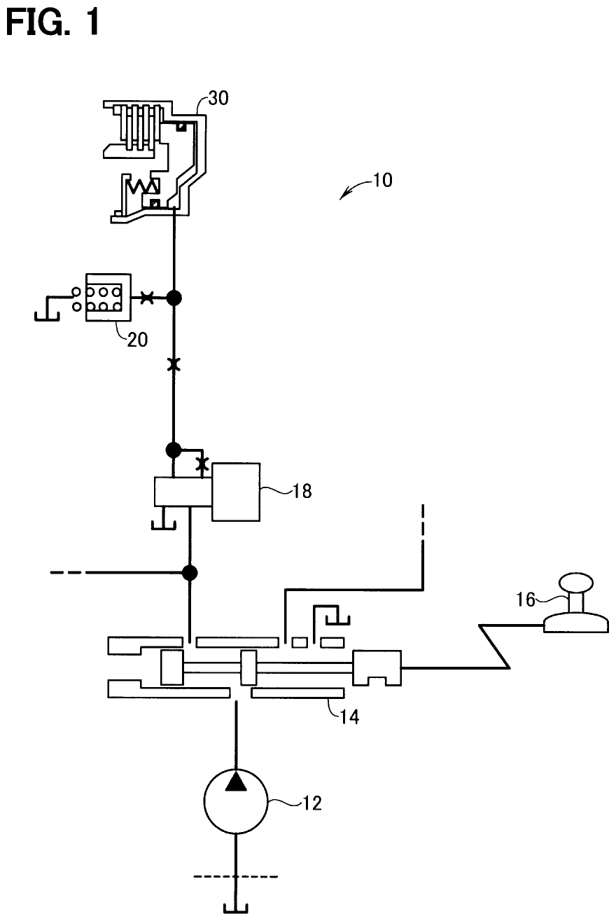

A hydraulic control device 10 shown in FIG.1 supplies a hydraulic pressure with a friction element 30 in an automatic transmission for a vehicle, such as a clutch and a brake. The hydraulic control device 10 has a hydraulic pump 12, a manual valve 14, a shift lever 16, a spool valve 18, and a damper 20.

The hydraulic pump 12 is a mechanical pump driven by a torque of an internal-combustion engine. The hydraulic pump 12 supplies oil with the manual valve 14. The manual valve 14 switches a supply destination of the oil from the hydraulic pump 12 between the friction element 30 for D range and the friction element 30 for R range according to the operation of the shift lever 16. The manual valve 14 sends the oil from the hydraulic pump 12 to the spool valve 18.

The spool valve 18 regulates the hydraulic pressure to the friction element 30 by regulating a supply amount of the oil to the friction element 30. The damper 20 is disposed between the spool valve 18 and the friction element 30, and suppresses a dynamic change of the hydraulic pressure to the friction element 30.

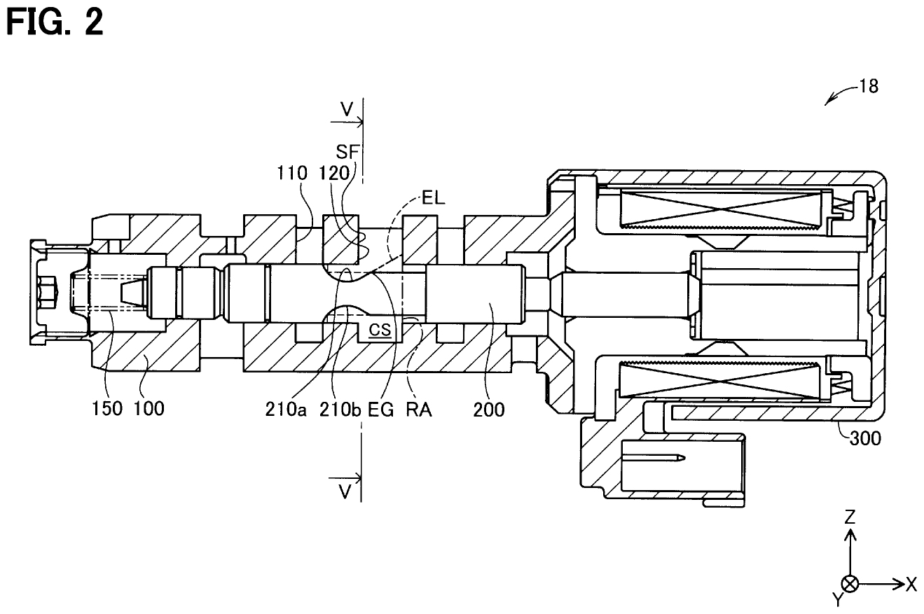

FIG. 2 is a schematic view of the spool valve 18 in accordance with the first embodiment. XYZ axes in FIG. 2 is three axes orthogonal each other in a space. The X axis is located along an axial direction of a sleeve 100 described later. A tip of the sleeve 100 is located on a second side (−X) in the axial direction and the opposite side is defined as a first side (+X). The Z axis is located along an opening direction of an inflow opening 110 described later. The direction where the fluid flows out from the sleeve 100 through the inflow opening 110 is defined as a +Z side, and the opposite direction is defined as a −Z side. The Y axis is orthogonal to the axial direction of the sleeve 100 and the opening direction of the inflow opening 110. When the tip of the sleeve 100 is viewed from an electromagnetic solenoid 300 described later, the right direction is defined as a +Y side, and the opposite direction is defined as a −Y side. The XYZ axes in FIG. 2 correspond to XYZ axes in other figures. The spool valve 18 has the sleeve 100, the spool 200, and the electromagnetic solenoid 300. In the spool valve 18 shown in FIG. 2, cross sections of a part of the sleeve 100 and the electromagnetic solenoid 300 are illustrated and an outer shape of the spool 200 is illustrated.

The sleeve 100 has a substantially tubular shape. The substantially tubular shape is configured with plural tubular shapes having different diameters shown in FIG. 2. In FIG. 2, an axial direction of the sleeve 100 is located along the X axis. The sleeve 100 has the inflow opening 110 and an outflow opening 120. The inflow opening 110 opens in a radial direction (+Z) of the sleeve 100. The inflow opening 110 takes the oil sent from the manual valve 14 into the sleeve 100. The outflow opening 120 opens in the radial direction (+Z). Specifically, the outflow opening 120 opens in the same direction as the opening direction of the inflow opening 110. The opening direction is a depth direction of the opening. The outflow opening 120 may open in other directions while the outflow opening 120 opens at the same side with the inflow opening 110 (+Z) relative to a XY plane. More specifically, when the inflow opening 110 opens on the +Z side in the radial direction, the outflow opening 120 can open in directions facing the +Z side in the radial direction relative to the XY plane. The XY plane is orthogonal to the opening direction of the inflow opening 110. The outflow opening 120 sends the oil, which is flowing from the inflow opening 110 through the sleeve 100, to the friction element 30.

In the first embodiment, cross sections of the inflow opening 110 and the outflow opening 120 taken along the XY plane, which is orthogonal to the Z axis, is rectangular. The cross section of the inflow opening 110 is the same at positions in the depth direction. The cross section of the outflow opening 120 is the same at positions in the depth direction. An opening area of the outflow opening 120 in the XY plane is larger than an opening area of the inflow opening 110 in the XY plane. A pressure loss in the outflow opening 120 is smaller than a pressure loss in the inflow opening 110. In other words, the pressure loss during the oil flowing in the outflow opening 120 is smaller than the pressure loss during the oil flowing in the inflow opening 110. Thus, the oil flows easier in the outflow opening 120. A relation between the inflow opening 110 and the outflow opening 120 is defined not only by a magnitude relation of the opening areas, but also by a magnitude relation of the pressure losses which indicates the degree of ease of oil flow.

A closed space CS is formed at the sleeve 100 opposite to where the outflow opening 120 is formed. In other words, the closed space CS is formed at the sleeve 100 on the −Z side, which is opposite to the +Z side where the outflow opening 120 is formed. The closed space CS is defined between the sleeve 100 and the spool at a location the farthest from the outflow opening 120 in the circumferential direction.

The spool 200 has a substantially stick shape. The substantially stick shape is configured with plural cylinder parts having different diameters as shown in FIG. 2. In FIG. 2, a center axis of the spool 200 is located along the X axis. The spool 200 is configured movable in the sleeve 100 in the axial direction of the sleeve 100. An inner space of the sleeve 100 housing the spool 200 is formed as the substantially cylinder shape.

The spool 200 has a recess 210a and a recess 210b. The recesses 210a and 210b are recessed from the outer peripheral part to the center axis of the spool 200 in the radial direction. In FIG. 2, the recess 210a is recessed from the +Z side to the center axis of the spool 200 in the radial direction. The recess 210b is recessed from the −Z side to the center axis of the spool 200 in the radial direction.

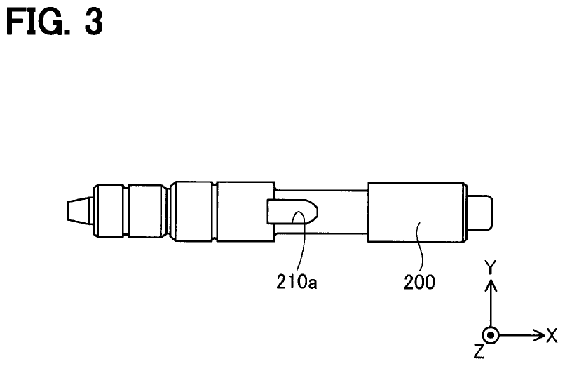

FIG. 3 is a top view of the spool 200 in FIG. 2 viewed from the +Z side. As shown in FIG. 3, the recess 210a faces the +Z side.

Suction power generated at the electromagnetic solenoid 300 moves the spool 200 in the sleeve 100 to the second side (−X) in the axial direction, such that the spool 200 moves away from the electromagnetic solenoid 300. The spool 200 controls a communication state between the inflow opening 110 and the outflow opening 120 through the recess 210a by positioning the recess 210a in the axial direction. The communication state is a state where the inflow opening 110 communicates with the outflow opening 120 through a space in the sleeve 100, and where the fluid can flow from the inflow opening 110 to the outflow opening 120. The control of the communication state means the regulation of opening degrees of the inflow opening 110 and the outflow opening 120 to the space in the sleeve 100.

The electromagnetic solenoid 300 is disposed on the first side (+X) from the sleeve 100. The electromagnetic solenoid 300 moves the spool 200 to the second side (−X) opposite from the first side (+X) in the axial direction by being energized. When the electromagnetic solenoid 300 is not energized, the spool 200 is energized to the first side (+X) by a spring 150 disposed on the second side (−X) of the sleeve 100.

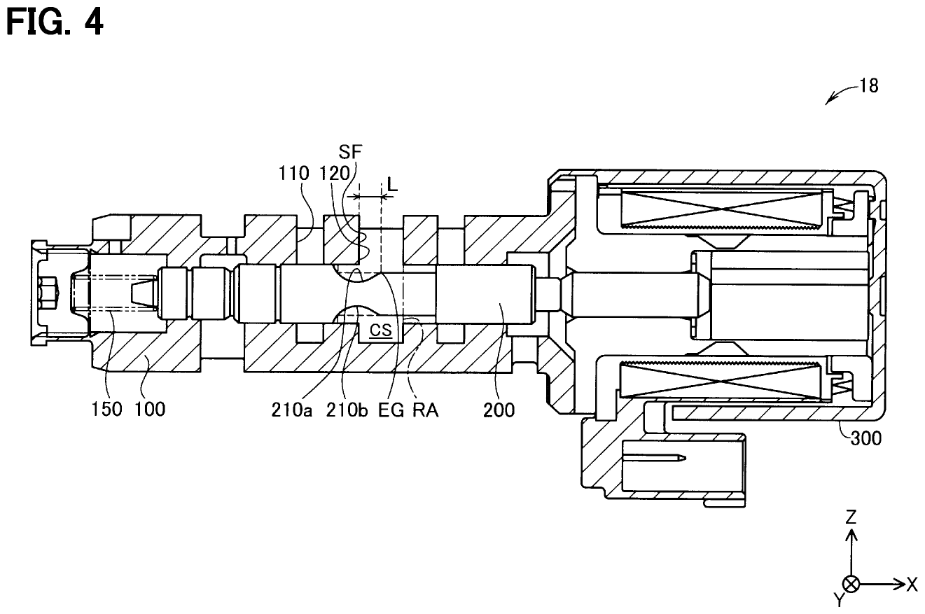

In FIG. 2, the electromagnetic solenoid 300 is slightly energized. When the spool 200 is moved to the second side (−X) from the position in FIG. 2, the fluid can flow in through the inflow opening 110 and flow out through the outflow opening 120. In FIG. 4, the electromagnetic solenoid 300 is not energized. In this case, the fluid cannot flow in through the inflow opening 110 and flow out through the outflow opening 120. The spool valve 18 is a normally close type, which does not supply the oil to the friction element 30 while the electromagnetic solenoid 300 is not energized.

In FIG. 2, an end of the inflow opening 110 on the first side (+X) overlaps with an end of the recess 210a on the second side (−X) along the Z axis. An extension line EL is extended from a tangent line at an end EG of the recess 210a on the first side (+X). The end EG is formed so that the extension line EL crosses a surface forming the outflow opening 120 on the first side (+X). This allows the oil to flow easily from the inflow opening 110 along the recess 210a to the outflow opening 120. Thus, the oil flow from the inflow opening 110 to the outflow opening 120 is easy to be formed. As with the shape of the end EG, a shape of an end of the recess 210b on the first side (+X) is defined. An extension line is extended from a tangent line at an end of the recess 210b on the first side (+X). When the spool 200 is rotated and the recess 210b faces on the +Z side in the opening direction, the end of the recess 210b on the first side (+X) is formed so that the extension line crosses a surface forming the outflow opening 120 on the first side (+X).

In FIG. 4, the end EG is disposed on the first side (+X) from a surface SF of the sleeve 100 forming the outflow opening 120 by a setting distance L. The surface SF defines the outflow opening 120 on the second side (−X). The setting distance L is larger than the maximum movable distance of the spool 200 to the second side (−X). Thus, when the spool 200 is moved to the second side (−X), the end EG is not positioned on the second side (−X) from the surface SF. This prevents a passage between the inflow opening 110 and the outflow opening 120 from getting narrow, which is caused by positioning the end EG between the inflow opening 110 and the outflow opening 120 in the axial direction.

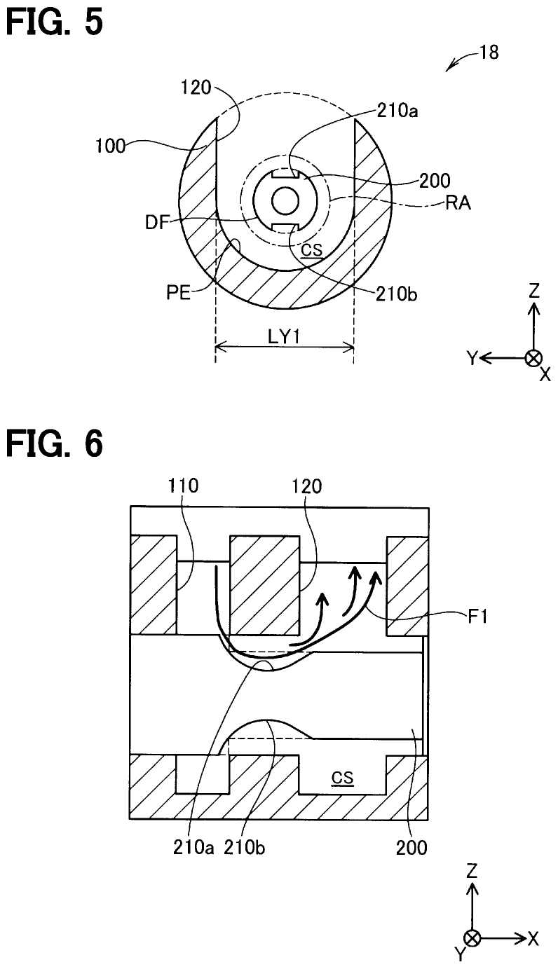

FIG. 5 is a cross section of the spool valve 18 taken along the YZ plane. The cross section in FIG. 5 is viewed from an arrow V in FIG. 2. In other words, FIG. 5 is a cross section of the spool valve 18 taken along the plane orthogonal to the axial direction of the spool 200 with including the outflow opening 120 in the axial direction of the spool 200. An inner surface PE of the sleeve 100 forming the closed space CS is curved surface. The inner surface PE indicates a surface forming the closed space CS, being located on the −Z side from the XY plane including the center axis of the spool 200. In other words, the inner surface is a surface of the sleeve 100 forming the closed space CS from the bottom of the closed space CS to the height of the center axis of the spool 200. In the first embodiment, the shape of the inner surface PE is half circle in the cross section, and the inner surface PE is extended in the axial direction. The shape of the inner surface PE is not limited to the first embodiment while the shape of the inner surface PE is curved surface.

A part of the spool 200 facing the closed space CS on the −Z side is defined as a peripheral surface DF. The distance between the peripheral surface DF and the inner surface PE is constant at positions in the radial direction, and 1 mm. The peripheral surface DF is a peripheral surface of the spool 200 located on the −Z side relative to the XY plane including the center axis of the spool 200. The recess 210a and the recess 210b are excluded from the peripheral surface DF. By setting the distance between the peripheral surface DF and the inner surface PE as constant, a narrower space, which retains the oil flow, is not formed between the peripheral surface DF and the inner surface PE. In other embodiments, the distance between the peripheral surface DF and the inner surface PE may not be constant. In such case, it is preferred that a minimum distance between the peripheral surface DF and the inner surface PE in the radial direction is selected in a range between 1 mm and 3 mm. By setting the distance in such the range, the space between the peripheral surface DF and the inner surface PE can be kept as a passage through which the oil can flow.

In FIG. 5, the recess 210a faces the +Z side and the recess 210b faces the closed space CS on the −Z side. A circle RA shown by dashed line surrounds the spool 200. As shown in FIG. 2, the circle RA shows an end of an inner space of the sleeve 100 defined by a wall of the sleeve 100 forming the outflow opening 120 on the first side (+X). As shown in FIG. 5, the opening width of the outflow opening 120 is the same with a maximum width LY1 of the inner space of the sleeve 100 along the Y axis.

FIG. 6 shows a vicinity of the inflow opening 110 and the outflow opening 120 of the spool valve 18. In FIG. 6, the electromagnetic solenoid 300 is energized and the spool 200 is moved to the second side (−X) compared to the state in FIG. 2. The recess 210a and the recess 210b are positioned as in FIG. 5. In this case, the oil flowing to the sleeve 100 forms a flow F1 that flows along the recess 210a and flows out smoothly from the outflow opening 120 to the friction element 30.

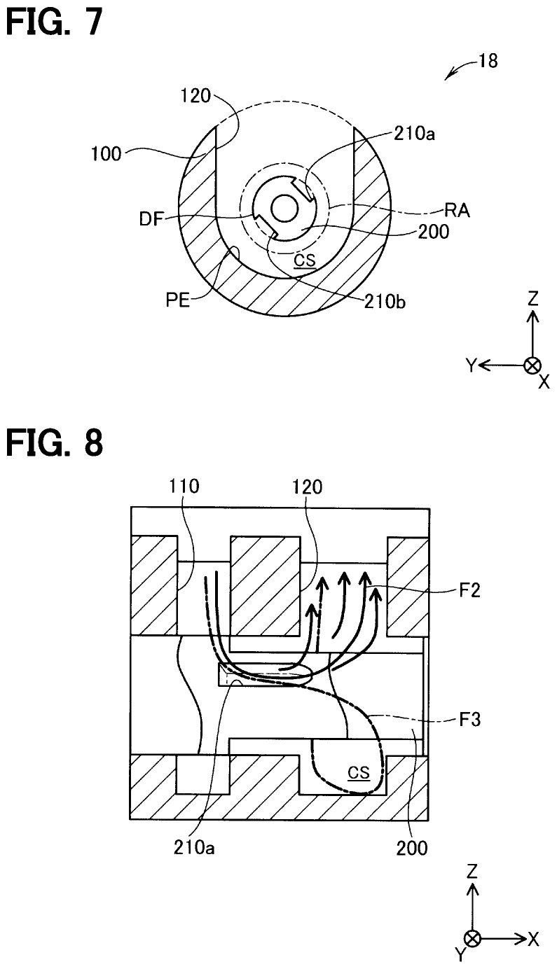

FIG. 7 shows a cross section of the spool valve 18 taken along the YZ plane. The recess 210a and the recess 210b in FIG. 7 face in different directions from in FIG. 5. In FIG. 7, the spool 200 is rotated by 45 degrees in the circumferential direction from the state in FIG. 5, so that the recess 210a is inclined by 45 degrees on the −Y side relative to the opening direction (Z-axis) and the recess 210b is inclined by 45 degrees on the +Y side relative to the opening direction (Z-axis).

FIG. 8 shows a vicinity of the inflow opening 110 and the outflow opening 120 in the spool valve 18. In FIG. 8, the electromagnetic solenoid 300 is energized and the spool 200 is moved to the second side (−X) as in FIG. 6. The recess 210a and the recess 210b face in the directions shown in FIG. 7. In this case, the oil flowing into the sleeve 100 forms a flow F2 and a flow F3. The oil flows along the recess 210a and out through the outflow opening 120 in the flow F2. The oil flows to the closed space CS along the recess 210a and then flows back to the outflow opening 120 in the flow F3. The flow F3 shows the direction where the fluid flows through the inflow opening 110 on the −Y side to the closed space CS and flows from the closed space CS on the +Y side to the outflow opening 120. As shown in the flow F3, the closed space CS guides the oil flowing from the recess 210a to the outflow opening 120. As shown in FIGS. 7 and 8, when the recess 210a is inclined by 45 degrees relative to the opening direction (Z-axis), the disturbance of the oil flow is still suppressed. As a result, the disturbance of the movement of the spool 200 in the axial direction, which is caused by the disturbance of the oil flow, is suppressed.

As shown in FIGS. 5 and 7, the inner surface PE forming the closed space CS is curved surface. The oil flows easier from the recess 210a to the closed space CS along the inner surface PE compared to the outer surface PE having an edge. As a result, the oil flow is prevented from being retained around the closed space CS. This suppresses the disturbance of the movement of the spool 200 in the axial direction caused by the retention of the oil flow around the closed space CS.

The pressure loss in the outflow opening 120 is smaller than the pressure loss in the inflow opening 110. The oil flows easier in the outflow opening 120 compared to the comparison example where the pressure loss in the outflow opening 120 is the same or larger than the pressure loss in the inflow opening 110. When the oil has a difficulty to flow in the outflow opening 120, the oil flow gets easy to be disturbed in the sleeve 100. The easy oil flow in the outflow opening 120 allows the suppression of the disturbance of the oil flow.

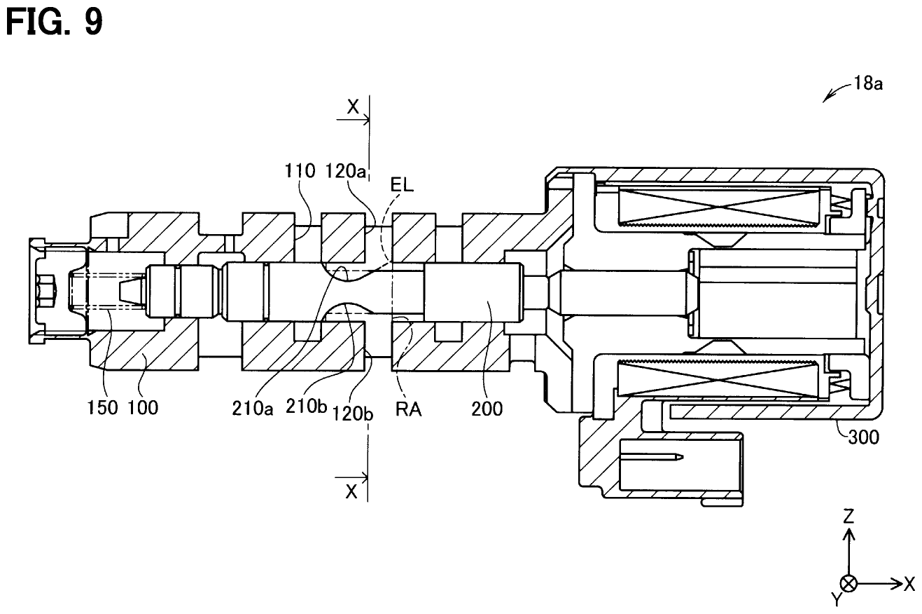

FIG. 9 is a schematic view of a spool valve 18a in a comparison example. The spool valve 18a has an outflow opening 120a and an outflow opening 120b in place of the outflow opening 120. The other structures of the spool valve 18a are the same in the first embodiment.

The outflow opening 120a opens on the +Z side in the opening direction. The cross section of the outflow opening 120a taken along the XY plane is rectangular. The cross section of the outflow opening 120a is the same at positions in the opening direction of the outflow opening 120a. The cross section area of the outflow opening 120a taken along the XY plane is the same with the cross section area of the inflow opening 110 taken along the XY plane. The pressure loss in the outflow opening 120a is the same with the pressure loss in the inflow opening 110.

The outflow opening 120b is formed at the sleeve 100 opposite to where the outflow opening 120a is formed. In other words, the outflow opening 120b is formed at the sleeve 100 on the −Z side which is opposite to the +Z side where the outflow opening 120a is formed. The cross section of the outflow opening 120b taken along the XY plane is rectangular. The cross section area of the outflow opening 120b taken along the XY plane is the same with the cross section area of the outflow opening 120a taken along the XY plane.

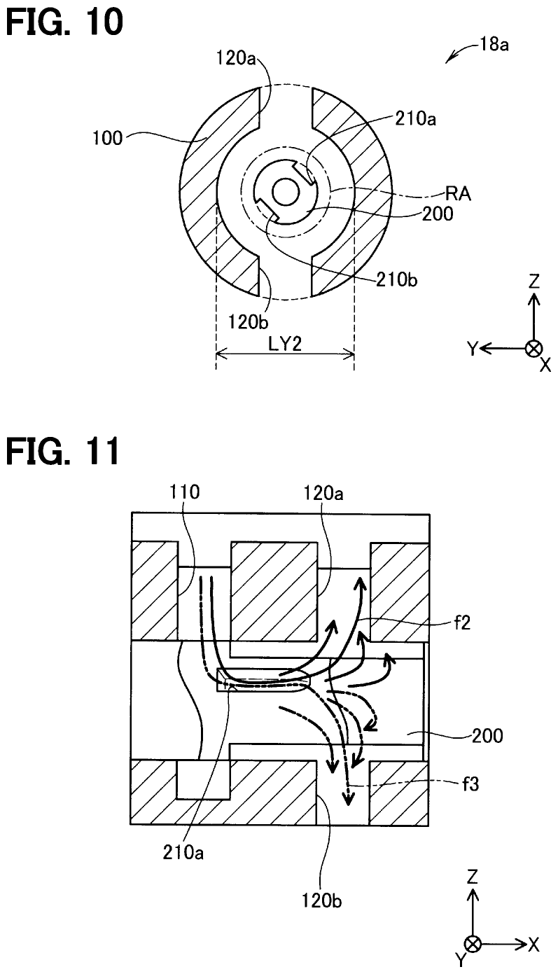

FIG. 10 shows the cross section of the spool valve 18a taken along the YZ plane. The cross section of the spool valve 18a in FIG. 10 is viewed from an arrow X in FIG. 9. As shown in FIG. 10, the opening widths of the outflow opening 120a and the outflow opening 120b are smaller than a maximum width LY2 of the inner space of the sleeve 100 along the Y axis. In FIG. 10, the spool is rotated by 45 degrees in the circumferential direction. The recess 210a is inclined by 45 degrees on the −Y side relative to the opening direction (Z-axis) of the outflow opening 120 and the recess 210b is inclined by 45 degrees on the +Y side relative to the opening direction (Z-axis) of the outflow opening 120.

FIG. 11 shows a vicinity of the inflow opening 110, the outflow opening 120a, and the outflow opening 120b of the spool valve 18a. In FIG. 11, the electromagnetic solenoid 300 is energized and the spool 200 is moved to the second side (−X). The recess 210a and the recess 210b are inclined as in FIG. 10. In this case, the oil flowing in the sleeve 100 forms a flow f2 and a flow f3. The oil flows along the recess 210a to the outflow opening 120a in the flow f2. The oil flows along the recess 210a to the outflow opening 120b in the flow f3.

The spool valve 18a has the outflow opening 120a and the outflow opening 120b. As shown in FIG. 11, when the electromagnetic solenoid 300 is energized and the recess 210a is inclined relative to the opening direction (Z-axis), the flow f2 and the flow f3 that have different flow directions of the oil are formed. The pressure loss in the outflow opening 120a is the same with the pressure loss in the inflow opening 110. The oil has a difficulty to flow in the outflow opening 120a compared to an example where the pressure loss in the outflow opening 120a is smaller than the pressure loss in the inflow opening 110. Thus, the flow f2 and the flow f3 that have the different flow directions are formed and in addition, the oil has a difficulty to flow in the outflow opening 120a. This generates the disturbance of the oil flow around the spool 200 between the outflow opening 120a and the outflow opening 120b. Such disturbance of the oil flow prevents the spool 200 from being moved in the axial direction.

On the other hand, the spool valve 18 in the first embodiment has the closed space CS. Thus, when the electromagnetic solenoid 300 is energized and the recess 210a is inclined relative to the opening direction (Z-axis), the flow F2 and the flow F3 having the same flow direction are formed. The pressure loss in the outflow opening 120 is smaller than the pressure loss in the inflow opening 110, which allows the oil to flow easier in the outflow opening 120. The flow F2 and the flow F3 having the same flow direction are formed and the oil flows easier in the outflow opening 120. This suppresses the disturbance of the oil flow around the spool 200 between the outflow opening 120 and the closed space CS. Thus, the disturbance of the movement of the spool 200 in the axial direction, which is caused by the disturbance of the oil flow, is suppressed.

When the spool 200 is rotated and the recess 210a is displaced from the desired position corresponding to the inflow opening 110 and the outflow opening 120, the oil may flow into the sleeve 100 opposite to where the outflow opening 120 is formed. In this case, according to the above-mentioned embodiment, the closed space CS located on the opposite side reverses the oil flow to the outflow opening 120. Thus, when the spool 200 of the spool valve 18 is rotated and the recess 210a is displaced from the desired position, the disturbance of the oil flow is suppressed. As a result, the disturbance of the movement of the spool 200 in the axial direction, which is caused by the disturbance of the oil flow, is suppressed.

### SECOND EMBODIMENT

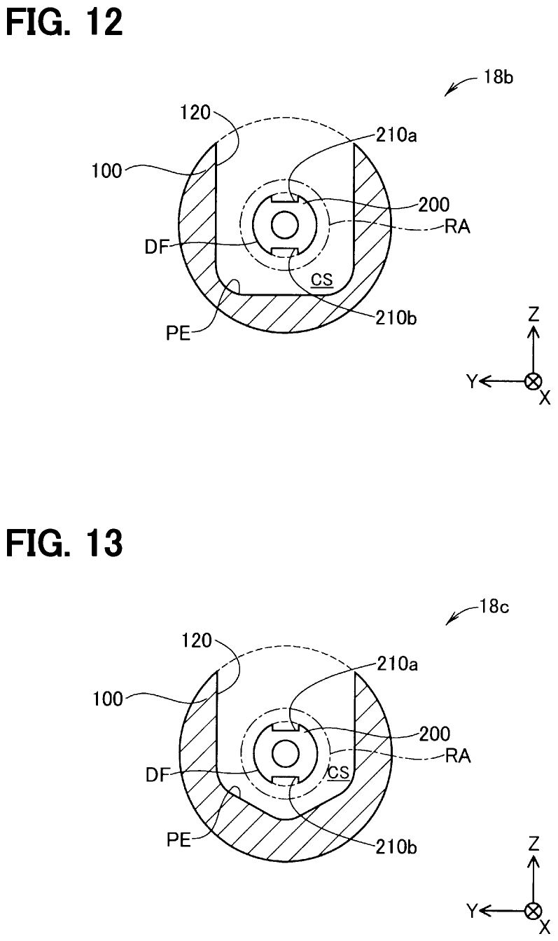

FIG. 12 shows a cross section of a spool valve 18b in the second embodiment taken along the YZ plane. The cross section in FIG. 12 corresponds to the cross section in the first embodiment in FIG. 5. The spool valve 18b is a modification of the first embodiment, and has a different shape of the inner surface PE forming the closed space CS. The other structures of the spool valve 18b are the same in the first embodiment. The shape of the inner surface PE of the spool valve 18b in the second embodiment is rectangular having rounded corners. The rectangular is extended along the center axis of the spool 200.

### THIRD EMBODIMENT

FIG. 13 shows a cross section of a spool valve 18c in the third embodiment taken along the YZ plane. The cross section in FIG. 13 corresponds to the cross section in the first embodiment in FIG. 5. The spool valve 18c in the third embodiment is a modification of the first embodiment, and has a different shape in the outer surface PE forming the closed space CS. In the spool valve 18c in the third embodiment, the inner surface PE is V-shaped having rounded edge. The V-shape is extended in the axial direction.

### FOURTH EMBODIMENT

FIG. 14 shows a cross section of a spool valve 18d in the fourth embodiment taken along the YZ plane. The cross section in FIG. 14 corresponds to the cross section in the first embodiment in FIG. 5. The spool valve 18d in the fourth embodiment is a modification of the first embodiment, and has a different opening width of the outflow opening 120 along the Y axis. In the spool valve 18c in the fourth embodiment, the opening width of the outflow opening 120 is wider than the maximum width LY1 of the inner space of the sleeve 100 shown in FIG. 14. In other words, the opening width of the outflow opening 120 is wider than the width of the inner surface PE.

### FIFTH EMBODIMENT

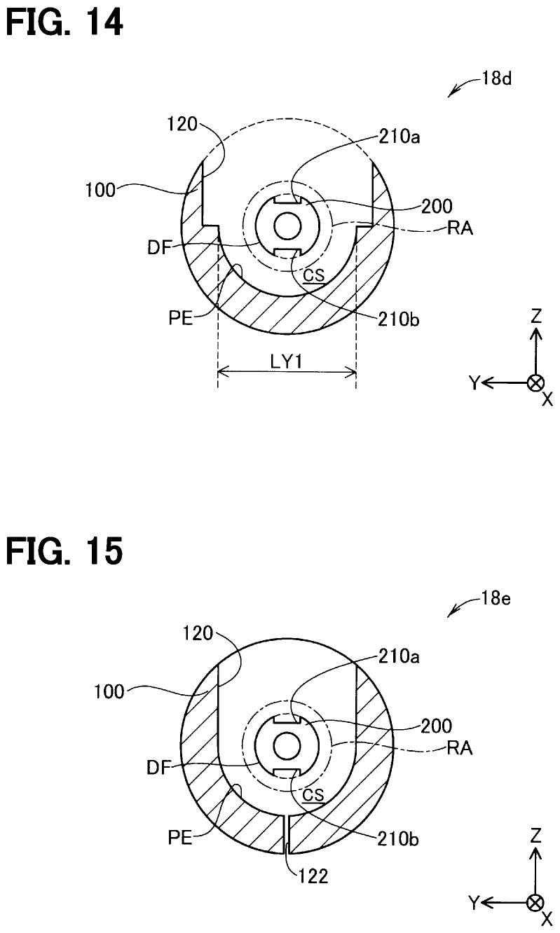

FIG. 15 shows the cross section of the spool valve 18e in the fifth embodiment taken along the YZ plane. The cross section in FIG. 16 corresponds to the cross section in the first embodiment in FIG. 5. The spool valve 18e in the fifth embodiment is a modification of the first embodiment, and has an opening 122. The spool valve 18e in the fifth embodiment has the opening 122 on the sleeve 100 forming the closed space CS. The opening width of the opening 122 taken along the XY plane is extremely smaller than the opening width of the outflow opening 120 taken along the XY plane. Thus, the oil flow formed by oil flowing out from the opening 122 does not disturb the oil flow reversed to the outflow opening 120 by the closed space CS in a large scale.

### OTHER EMBODIMENT

In the first embodiment described above, the cross section of the inflow opening 110 taken along the XY plane is the same at positions in the depth direction. The cross section of the outflow opening 120 taken along the XY plane is the same at positions in the depth direction. However, this disclosure is not limited to this. The cross section of the inflow opening 110 taken along the XY plane may not be the same in the depth direction and the cross section of the outflow opening 120 taken along the XY plane may not be the same in the depth direction. In this case, it is preferred that the minimum cross section area of the outflow opening 120 is larger than the minimum cross section area of the inflow opening 110. The shapes of the inflow opening 110 and the outflow opening 120 are appropriately selected so that the amount of the oil flowing into the inflow opening 110 is larger than the amount of the oil flowing out thorough the outflow opening 120.

When the cross section of the outflow opening 120 taken along the XY plane is not the same at positions in the depth direction, it is preferred that the end EG is formed as described below. The extension line EL crosses the surface forming the outflow opening 120 on the first side (+X) and on the +Z side from a part of the surface defining the minimum opening width. In this case, the oil flow flowing from the inflow opening 110 along the recess 210a is guided to the +Z side from the part defining the minimum opening width. This allows the oil to flow out smoothly thorough the outflow opening 120 to the friction element 30.

It should be appreciated that the present disclosure is not limited to the embodiments and variations described above and can be modified appropriately within the scope of the appended claims. For example, the technical features in each embodiment and variation can be replaced and combined appropriately to solve a part or all of the issues or to achieve a part or all of the effects. In addition, the technical features can be deleted appropriately as long as the features are explained as essential in the present description.

What is claimed is:

1. A spool valve comprising:
a sleeve having a tubular shape; and
a spool disposed in the sleeve, wherein
the sleeve has an inflow opening through which fluid flows in and an outflow opening through which fluid flows out,
the inflow opening opens in a radial direction of the sleeve and the outflow opening opens a same side with the inflow opening,
the spool has a recess recessed from an outer peripheral part of the spool to a center axis of the spool,
the spool is configured movable in the sleeve in an axial direction of the sleeve,
the spool controls a communication state between the inflow opening and the outflow opening through the recess by regulating a position of the recess in the axial direction, and
a closed space is formed at a portion of the sleeve opposite to where the outflow opening is located.

2. The spool valve according to claim 1, wherein
a pressure loss in the outflow opening is smaller than a pressure loss in the inflow opening.

3. The spool valve according to claim 1, wherein
the inflow opening has an end on a first side in the axial direction,
the recess has an end on a second side opposite to the first side in the axial direction, and
when the end of the inflow opening on the first side overlaps with the end of the recess on the second side in a direction orthogonal to the axial direction,
an extension line extended from a tangent line at an end of the recess on the first side crosses a surface of the sleeve forming the outflow opening on the first side.

4. The spool valve according to claim 1, wherein
an inner surface of the sleeve forming the closed space is curve-shaped.

5. The spool valve according to claim 1, wherein
the spool has a surface which faces the closed space,
the sleeve has an inner surface forming the closed space, and
a distance between the surface of the spool from which the recess is excluded and the inner surface of the sleeve in a radial direction is constant in a cross section orthogonal to the axial direction.

6. The spool valve according to claim 1, wherein
the spool has a surface which faces the closed space,
the sleeve has an inner surface forming the closed space, and
a minimum distance between the surface of the spool from which the recess is excluded and the inner surface of the sleeve in a cross section orthogonal to the axial direction is in a range between 1 mm and 3 mm.

7. The spool valve according to claim 1, wherein
the recess has an end on a first side in the axial direction,
the outflow opening has a surface on a second side opposite to the first side in the axial direction,
the end of the recess is disposed on the first side from the surface of the outflow opening in the axial direction by a setting distance, and
the setting distance is larger than a maximum movable distance where the spool is movable to the second side.
